(19) United States
(12) Patent Application Publication
(10) Pub. No.: US 2023/0064097 A1
(43) Pub. Date: Mar. 2, 2023

(54) DIFFRACTIVE OPTICAL ELEMENT (DOE) ON AN IMAGING SENSOR TO REDUCE AND MINIMIZE FLARE

(71) Applicant: Meta Platforms Technologies, LLC, Menlo Park, CA (US)

(72) Inventors: Wanyue SONG, Sunnyvale, CA (US); Youngshik YOON, Cupertino, CA (US); Zheng SUN, Sunnyvale, CA (US); Woong HWANG, Seoul (KR)

(73) Assignee: Meta Platforms Technologies, LLC, Menlo Park, CA (US)

(21) Appl. No.: 17/412,499

(22) Filed: Aug. 26, 2021

(51) Int. Cl. G02B 27/00; G02B 27/42; H04N 5/225

(52) U.S. Cl. CPC G02B 27/0037; G02B 27/4205; H04N 5/2254; G06F 3/013

(57) ABSTRACT

An imaging sensor assembly to reduce flare and ghost effects and enhance sharpness in a head-mounted device (HMD) is provided. The imaging sensor assembly may include a diffractive optical element (DOE). The imaging sensor assembly may also include a sensor substrate under the diffractive optical element (DOE). In some examples, the sensor substrate may include a plurality of color filters, and a plurality of photodiodes to detect optical illumination that passes through the diffractive optical element (DOE) to create one or more images.

### TECHNICAL FIELD

This patent application relates generally to optical lens design and configurations in optical systems, such as head-mounted displays (HMDs), and more specifically, to systems and methods for flare reduction and resolution improve diffractive optical element (DOE) on an imaging sensor in an optical device.

### BACKGROUND

Optical lens design and configurations are part of many modem-day devices, such as cameras used in mobile phones and various optical devices. One such optical device that relies on optical lens design is a head-mounted display (HMD). In some examples, a head-mounted display (HMD) may be a headset or eyewear used for video playback, gaming, or sports, and in a variety of contexts and applications, such as virtual reality (VR), augmented reality (AR), or mixed reality (MR).

Some head-mounted displays (HMDs) rely on a plurality of imaging sensors that detect optical signals. To do this, an imaging sensor may be equipped with one or more photodiodes. However, because of the way some conventional imaging sensors are configured, not all of the rays or optical signals reaches the photodiode. And to the extent that these optical signals do reach the photodiode, the surface of imaging sensor may cause unwanted flare or ghost effects.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of a system associated with a head-mounted display (HMD), according to an example.

FIGS. 2A-2B illustrate various head-mounted displays (HMDs), in accordance with an example.

FIGS. 3A-3C illustrate schematic diagrams of various imaging sensor configurations, according to an example.

FIG. 4 illustrates a flare or ghost effect of an imaging sensor configuration using a micro lens array (MLA), according to an example.

FIG. 5 illustrates a schematic diagram of an imaging sensor configuration using a diffractive optical element (DOE), according to an example.

FIGS. 6A-6C illustrate schematic diagrams of various diffractive optical elements (DOEs) for an imaging sensor configuration, according to an example.

FIG. 7 illustrates a flow chart of a method for providing a diffractive optical element (DOE) in an imaging sensor configuration, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

There are many types of optical devices that utilize imaging sensor technologies. These may include cameras or any number of optical devices. An imaging sensor may be particularly vital in a head-mounted display (HMD), which is an optical device that may communicate information to or from a user who is wearing the headset. For example, a virtual reality (VR) headset may be used to present visual information to simulate any number of virtual environments when worn by a user. That same virtual reality (VR) headset may also receive information from the user’s eye movements, head/body shifts, voice, or other user-provided signals. Many of the features of a head-mounted display (HMD) may use imaging sensor technologies.

In many cases, advancements in imaging sensor configurations may seek to decrease size, weight, cost, and overall bulkiness while improving performance, resolution, and efficiency. However, attempts to provide a cost-effective device with a small form factor often limits the function performance of the head-mounted display (HMD). For example, reducing the size and bulkiness of various optical configurations, e.g., within the imaging sensor, may also reduce the amount of space. In doing so, an imaging sensor configuration may not be able to utilize or detect all the optical illumination and therefore limit or restrict a headset’s ability to function at full capacity. And even if the headset is able to utilize all its functions and features, an imaging sensor may cause undesirable effects, such as flares or ghosts.

The systems and methods described herein may provide flare or ghost reduction by using a diffractive optical element (DOE) on an imaging sensor in an optical device. A conventional imaging sensor may rely on a micro lens array (MLA) to focus or project more optical illumination on a photodiode of an imaging sensor, the surface or shape of the micro lens array (MLA), however, may cause unwanted flare or ghost effects. The systems and methods described herein may provide a diffractive optical element (DOE) to alleviate or reduce flare or ghost effects. An advantage of using a diffractive optical element (DOE) rather than a micro lens array (MLA) is that the surface or shape of the diffractive optical element (DOE) may produce substantially less flare or ghost effects. Furthermore, a diffractive optical element (DOE) may be more easily provided on top of the sensor layer, thus enabling a more cost-effective and efficient solution to conventional MLA-based imaging sensors. In other words, by providing a diffractive optical element (DOE) over an imaging sensor, the systems and methods described herein may provide a flexible and low-cost way to improve visual acuity, minimize flare or ghosts, without increasing size, thickness, cost, or overall bulkiness of the imaging sensor. These and other examples will be described in more detail herein.

It should also be appreciated that the systems and methods described herein may be particularly suited for virtual reality (VR), augmented reality (AR), and/or mixed reality (MR) environments, but may also be applicable to a host of other systems or environments that include imaging sensor configurations or similar optical assemblies. These may include, for example, cameras, networking, telecommunications, holography, or other optical systems. Thus, the optical configurations described herein, may be used in any of these or other examples. These and other benefits will be apparent in the description provided herein.

### System Overview

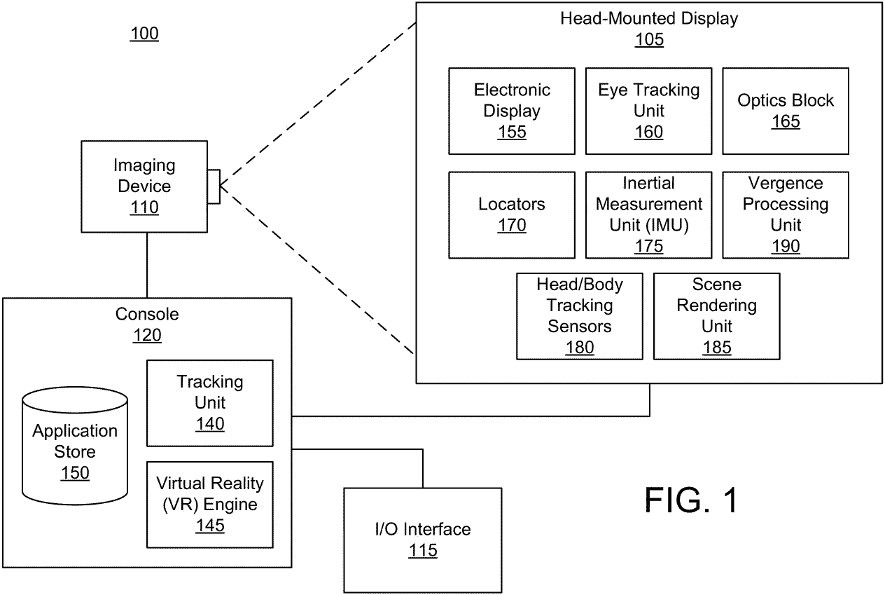

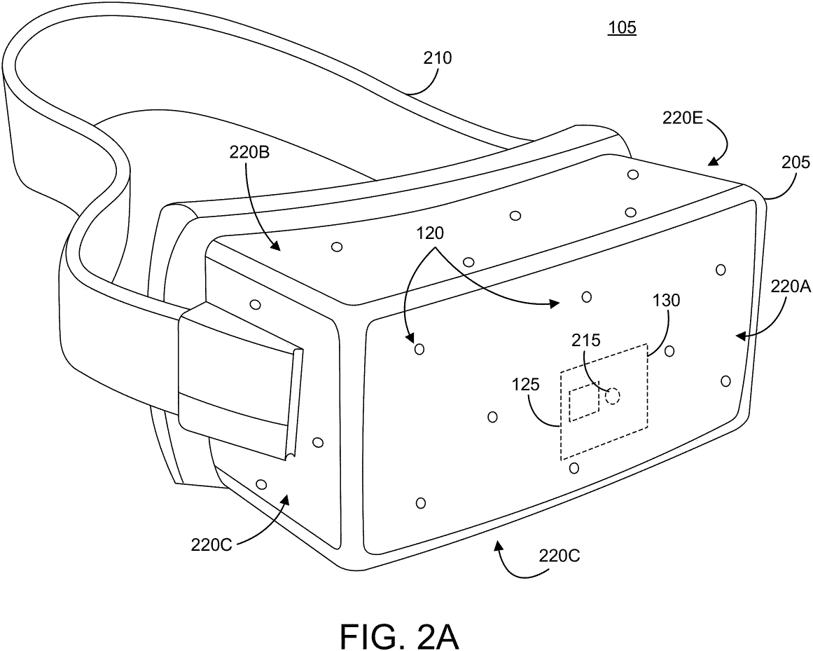

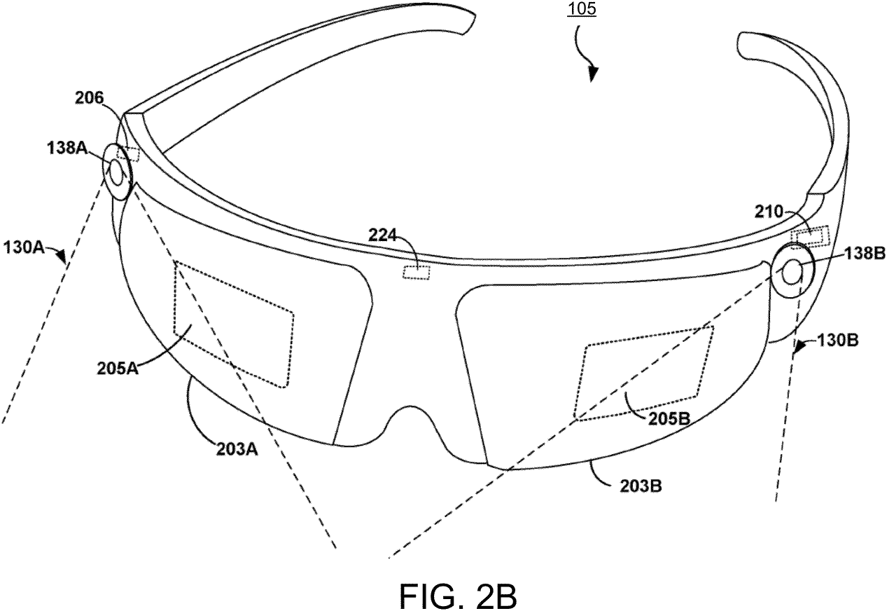

Reference is made to FIGS. 1 and 2A-2B. FIG. 1 illustrates a block diagram of a system 100 associated with a head-mounted display (HMD), according to an example. The system 100 may be used as a virtual reality (VR) system, an augmented reality (AR) system, a mixed reality (MR) system, or some combination thereof, or some other related system. It should be appreciated that the system 100 and the head-mounted display (HMD) 105 may be exemplary illustrations. Thus, the system 100 and/or the head-mounted display (HMD) 105may or not include additional features and some of the features described herein may be removed and/or modified without departing from the scopes of the system 100 and/or the head-mounted display (HMD) 105 outlined herein.

In some examples, the system 100 may include the head-mounted display (HMD) 105, an imaging device 110, and an input/output (I/O) interface 115, each of which may be communicatively coupled to a console 120 or other similar device.

While FIG. 1 shows a single head-mounted display (HMD) 105, a single imaging device 110, and an I/O interface 115, it should be appreciated that any number of these components may be included in the system 100. For example, there may be multiple head-mounted displays (HMDs) 105, each having an associated input interface 115 and being monitored by one or more imaging devices 110. with each head-mounted display (HMD) 105, I/O interface 115, and imaging devices 110 communicating with the console 120. In alternative configurations, different and/or additional components may also be included in the system 100. As described herein, the head-mounted display (HMD) 105 may act be used as a virtual reality (VR), augmented reality (AR), and/or a mixed reality (MR) head-mounted display (HMD). A mixed reality (MR) and/or augmented reality (AR) head-mounted display (HMD), for instance, may augment views of a physical, real-world environment with computer-generated elements (e.g., images, video, sound, etc.).

The head-mounted display (HMD) 105 may communicate information to or from a user who is wearing the headset. In some examples, the head-mounted display (HMD) 105 may provide content to a user, which may include, but not limited to, images, video, audio, or some combination thereof. In some examples, audio content may be presented via a separate device (e.g., speakers and/or headphones) external to the head-mounted display (HMD) 105 that receives audio information from the head-mounted display (HMD) 105, the console 120, or both. In some examples, the head-mounted display (HMD) 105 may also receive information from a user. This information may include eye moments, head/body movements, voice (e.g.. using an integrated or separate microphone device), or other user-provided content.

The head-mounted display (HMD) 105 may include any number of components, such as an electronic display 155, an eye tracking unit 160. an optics block 165, one or more locators 170, an inertial measurement unit (IMU) 175, one or head/body tracking sensors 180, and a scene rendering unit 185, and a vergence processing unit 190.

While the head-mounted display (HMD) 105 described in FIG. 1 is generally within a VR context as part of a VR system environment, the head-mounted display (HMD) 105 may also be part of other HMD systems such as, for example, an AR system environment. In examples that describe an AR system or MR system environment, the head-mounted display (HMD) 105 may augment views of a physical, real-world environment with computer-generated elements (e.g., images, video, sound, etc.).

An example of the head-mounted display (HMD) 105 is further described below in conjunction with FIG. 2. The head-mounted display (HMD) 105 may include one or more rigid bodies, which may be rigidly or non-rigidly coupled to each other together. A rigid coupling between rigid bodies causes the coupled rigid bodies to act as a single rigid entity. In contrast, a non-rigid coupling between rigid bodies allows the rigid bodies to move relative to each other.

The electronic display 155 may include a display device that presents visual data to a user. This visual data may be transmitted, for example, from the console 120. In some examples, electronic display 155 may also present tracking light for tracking the user’s eye movements. It should be appreciated that the electronic display 155 may include any number of electronic display elements (e.g., a display for each of the user). Examples of a display device that may be used in the electronic display 155 may include, but not limited to a liquid crystal display (LCD), a light emitting diode (LED), an organic light emitting diode (OLED) display, an active-matrix organic light-emitting diode (AMOLED) display, micro light emitting diode (micro-LED) display, some other display, or some combination thereof.

The optics block 165 may adjust its focal length based on or in response to instructions received from the console 120 or other component. In some examples, the optics block 165 may include a multi multifocal block to adjust a focal length (adjusts optical power) of the optics block 165.

The eye tracking unit 160 may track an eye position and eye movement of a user of the head-mounted display (HMD) 105. A camera or other optical sensor inside the head-mounted display (HMD) 105 may capture image information of a user’s eyes, and the eye tracking unit 160 may use the captured information to determine interpupillary distance, interocular distance, a three-dimensional (3D) position of each eye relative to the head-mounted display (HMD) 105 (e.g., for distortion adjustment purposes), including a magnitude of torsion and rotation (i.e., roll, pitch, and yaw) and gaze directions for each eye. The information for the position and orientation of the user’s eyes may be used to determine the gaze point in a virtual scene presented by the head-mounted display (HMD) 105 where the user is looking.

The vergence processing unit 190 may determine a vergence depth of a user’s gaze. In some examples, this may be based on the gaze point or an estimated intersection of the gaze lines determined by the eye tracking unit 160. Vergence is the simultaneous movement or rotation of both eyes in opposite directions to maintain single binocular vision, which is naturally and/or automatically performed by the human eye. Thus, a location where a user’s eyes are verged may refer to where the user is looking and may also typically be the location where the user’s eyes are focused. For example, the vergence processing unit 190 may triangulate the gaze lines to estimate a distance or depth from the user associated with intersection of the gaze lines. The depth associated with intersection of the gaze lines can then be used as an approximation for the accommodation distance, which identifies a distance from the user where the user’s eyes are directed. Thus, the vergence distance allows determination of a location where the user’s eyes should be focused.

The one or more locators 170 may be one or more objects located in specific positions on the head-mounted display (HMD) 105 relative to one another and relative to a specific reference point on the head-mounted display (HMD) 105. A locator 170, in some examples, may be a light emitting diode (LED), a corner cube reflector, a reflective marker, and/or a type of light source that contrasts with an environment in which the head-mounted display (HMD) 105 operates, or some combination thereof. Active locators 170 (e.g., an LED or other type of light emitting device) may emit light in the visible band (“380 nm to 850 nm), in the infrared (IR) band ("850 nm to 1 mm), in the ultraviolet band (10 nm to 380 nm), some other portion of the electromagnetic spectrum, or some combination thereof.

The one or more locators 170 may be located beneath an outer surface of the head-mounted display (HMD) 105, which may be transparent to wavelengths of light emitted or reflected by the locators 170 or may be thin enough not to substantially attenuate wavelengths of light emitted or reflected by the locators 170. Further, the outer surface or other portions of the head-mounted display (HMD) 105 may be opaque in the visible band of wavelengths of light. Thus, the one or more locators 170 may emit light in the IR band while under an outer surface of the head-mounted display (HMD) 105 that may be transparent in the IR band but opaque in the visible band.

The inertial measurement unit (IMU) 175 may be an electronic device that generates, among other things, fast calibration data based on or in response to measurement signals received from one or more of the head/body tracking sensors 180, which may generate one or more measurement signals in response to motion of head-mounted display (HMD) 105. Examples of the head/body tracking sensors 180 may include, but not limited to, accelerometers, gyroscopes, magnetometers, cameras, other sensors suitable for detecting motion, correcting error associated with the inertial measurement unit (IMU) 175, or some combination thereof. The head/body tracking sensors 180 may be located external to the inertial measurement unit (IMU) 175, internal to the inertial measurement unit (IMU) 175, or some combination thereof.

Based on or in response to the measurement signals from the head/body tracking sensors 180, the inertial measurement unit (IMU) 175 may generate fast calibration data indicating an estimated position of the head-mounted display (HMD) 105 relative to an initial position of the head-mounted display (HMD) 105. For example, the head/body tracking sensors 180 may include multiple accelerometers to measure translational motion (forward/back, up/down, left/right) and multiple gyroscopes to measure rotational motion (e.g., pitch, yaw, and roll). The inertial measurement unit (IMU) 175 may then, for example, rapidly sample the measurement signals and/or calculate the estimated position of the head-mounted display (HMD) 105 from the sampled data. For example, the inertial measurement unit (IMU) 175 may integrate measurement signals received from the accelerometers over time to estimate a velocity vector and integrates the velocity vector over time to determine an estimated position of a reference point on the head-mounted display (HMD) 105. It should be appreciated that the reference point may be a point that may be used to describe the position of the head-mounted display (HMD) 105. While the reference point may generally be defined as a point in space, in various examples or scenarios, a reference point as used herein may be defined as a point within the head-mounted display (HMD) 105 (e.g., a center of the inertial measurement unit (IMU) 175). Alternatively or additionally, the inertial measurement unit (IMU) 175 may provide the sampled measurement signals to the console 120, which may determine the fast calibration data or other similar or related data.

The inertial measurement unit (IMU) 175 may additionally receive one or more calibration parameters from the console 120. As described herein, the one or more calibration parameters may be used to maintain tracking of the head-mounted display (HMD) 105. Based on a received calibration parameter, the inertial measurement unit (IMU) 175 may adjust one or more of the IMU parameters (e.g., sample rate). In some examples, certain calibration parameters may cause the inertial measurement unit (IMU) 175 to update an initial position of the reference point to correspond to a next calibrated position of the reference point. Updating the initial position of the reference point as the next calibrated position of the reference point may help reduce accumulated error associated with determining the estimated position. The accumulated error, also referred to as drift error, may cause the estimated position of the reference point to “drift” away from the actual position of the reference point over time.

The scene rendering unit 185 may receive content for the virtual scene from a VR engine 145 and may provide the content for display on the electronic display 155. Additionally or alternatively, the scene rendering unit 185 may adjust the content based on information from the inertial measurement unit (IMU) 175, the vergence processing unit 830, and/or the head/body tracking sensors 180. The scene rendering unit 185 may determine a portion of the content to be displayed on the electronic display 155 based at least in part on one or more of the tracking unit 140, the head/body tracking sensors 180, and/or the inertial measurement unit (IMU) 175.

The imaging device 110 may generate slow calibration data in accordance with calibration parameters received from the console 120. Slow calibration data may include one or more images showing observed positions of the locators 125 that are detectable by imaging device 110. The imaging device 110 may include one or more cameras, one or more video cameras, other devices capable of capturing images including one or more locators 170, or some combination thereof. Additionally, the imaging device 110 may include one or more filters (e.g., for increasing signal to noise ratio). The imaging device 110 may be configured to detect light emitted or reflected from the one or more locators 170 in a field of view of the imaging device 110. In examples where the locators 170 include one or more passive elements (e.g., a retroreflector), the imaging device 110 may include a light source that illuminates some or all of the locators 170, which may retro-reflect the light towards the light source in the imaging device 110. Slow calibration data may be communicated from the imaging device 110 to the console 120, and the imaging device 110 may receive one or more calibration parameters from the console 120 to adjust one or more imaging parameters (e.g., focal length, focus, frame rate, ISO, sensor temperature, shutter speed, aperture, etc.).

The I/O interface 115 may be a device that allows a user to send action requests to the console 120. An action request may be a request to perform a particular action. For example, an action request may be to start or end an application or to perform a particular action within the application. The I/O interface 115 may include one or more input devices. Example input devices may include a keyboard, a mouse, a hand-held controller, a glove controller, and/or any other suitable device for receiving action requests and communicating the received action requests to the console 120. An action request received by the I/O interface 115 may be communicated to the console 120, which may perform an action corresponding to the action request. In some examples, the I/O interface 115 may provide haptic feedback to the user in accordance with instructions received from the console 120. For example, haptic feedback may be provided by the I/O interface 115 when an action request is received, or the console 120 may communicate instructions to the I/O interface 115 causing the I/O interface 115 to generate haptic feedback when the console 120 performs an action.

The console 120 may provide content to the head-mounted display (HMD) 105 for presentation to the user in accordance with information received from the imaging device 110, the head-mounted display (HMD) 105, or the I/O interface 115. The console 120 includes an application store 150, a tracking unit 140, and the VR engine 145. Some examples of the console 120 have different or additional units than those described in conjunction with FIG. 1. Similarly, the functions further described below may be distributed among components of the console 120 in a different manner than is described here.

The application store 150 may store one or more applications for execution by the console 120, as well as other various application-related data. An application, as used herein, may refer to a group of instructions, that when executed by a processor, generates content for presentation to the user. Content generated by an application may be in response to inputs received from the user via movement of the head-mounted display (HMD) 105 or the I/O interface 115. Examples of applications may include gaming applications, conferencing applications, video playback application, or other applications.

The tracking unit 140 may calibrate the system 100. This calibration may be achieved by using one or more calibration parameters and may adjust one or more calibration parameters to reduce error in determining position of the head-mounted display (HMD) 105. For example, the tracking unit 140 may adjust focus of the imaging device 110 to obtain a more accurate position for observed locators 170 on the head-mounted display (HMD) 105. Moreover, calibration performed by the tracking unit 140 may also account for information received from the inertial measurement unit (IMU) 175. Additionally, if tracking of the head-mounted display (HMD) 105 is lost (e.g., imaging device 110 loses line of sight of at least a threshold number of locators 170), the tracking unit 140 may re-calibrate some or all of the system 100 components.

Additionally, the tracking unit 140 may track the movement of the head-mounted display (HMD) 105 using slow calibration information from the imaging device 110 and may determine positions of a reference point on the head-mounted display (HMD) 105 using observed locators from the slow calibration information and a model of the head-mounted display (HMD) 105. The tracking unit 140 may also determine positions of the reference point on the head-mounted display (HMD) 105 using position information from the fast calibration information from the inertial measurement unit (IMU) 175 on the head-mounted display (HMD) 105. Additionally, the eye tracking unit 160 may use portions of the fast calibration information, the slow calibration information, or some combination thereof, to predict a future location of the head-mounted display (HMD) 105, which may be provided to the VR engine 145.

The VR engine 145 may execute applications within the system 100 and may receive position information, acceleration information, velocity information, predicted future positions, other information, or some combination thereof for the head-mounted display (HMD) 105 from the tracking unit 140 or other component. Based on or in response to the received information, the VR engine 145 may determine content to provide to the head-mounted display (HMD) 105 for presentation to the user. This content may include, but not limited to, a virtual scene, one or more virtual objects to overlay onto a real world scene, etc.

In some examples, the VR engine 145 may maintain focal capability information of the optics block 165. Focal capability information, as used herein, may refer to information that describes what focal distances are available to the optics block 165. Focal capability information may include, e.g., a range of focus the optics block 165 is able to accommodate (e.g., 0 to 4 diopters), a resolution of focus (e.g., 0.25 diopters), a number of focal planes, combinations of settings for switchable half wave plates (SHWPs) (e.g., active or non-active) that map to particular focal planes, combinations of settings for SHWPS and active liquid crystal lenses that map to particular focal planes, or some combination thereof.

The VR engine 145 may generate instructions for the optics block 165. These instructions may cause the optics block 165 to adjust its focal distance to a particular location. The VR engine 145 may generate the instructions based on focal capability information and, e.g., information from the vergence processing unit 190, the inertial measurement unit (IMU) 175, and/or the head/body tracking sensors 180. The VR engine 145 may use information from the vergence processing unit 190, the inertial measurement unit (IMU) 175, and the head/body tracking sensors 180, other source, or some combination thereof, to select an ideal focal plane to present content to the user. The VR engine 145 may then use the focal capability information to select a focal plane that is closest to the ideal focal plane. The VR engine 145 may use the focal information to determine settings for one or more SHWPs, one or more active liquid crystal lenses, or some combination thereof, within the optics block 176 that are associated with the selected focal plane. The VR engine 145 may generate instructions based on the determined settings, and may provide the instructions to the optics block 165.

The VR engine 145 may perform any number of actions within an application executing on the console 120 in response to an action request received from the I/O interface 115 and may provide feedback to the user that the action was performed. The provided feedback may be visual or audible feedback via the head-mounted display (HMD) 105 or haptic feedback via the I/O interface 115.

FIGS. 2A-2B illustrate various head-mounted displays (HMDs), in accordance with an example. FIG. 2A shows a head-mounted display (HMD) 105, in accordance with an example. The head-mounted display (HMD) 105 may include a front rigid body 205 and a band 210. The front rigid body 205 may include an electronic display (not shown), an inertial measurement unit (IMU) 175, one or more position sensors (e.g., head/body tracking sensors 180), and one or more locators 170, as described herein. In some examples, a user movement may be detected by use of the inertial measurement unit (IMU) 175, position sensors (e.g., headlbody tracking sensors 180), and/or the one or more locators 170, and an image may be presented to a user through the electronic display based on or in response to detected user movement. In some examples, the head-mounted display (HMD) 105 may be used for presenting a virtual reality, an augmented reality, or a mixed reality environment.

At least one position sensor, such as the head/body tracking sensor 180 described with respect to FIG. 1, may generate one or more measurement signals in response to motion of the head-mounted display (HMD) 105. Examples of position sensors may include: one or more accelerometers, one or more gyroscopes, one or more magnetometers, another suitable type of sensor that detects motion, a type of sensor used for error correction of the inertial measurement unit (IMU) 175, or some combination thereof. The position sensors may be located external to the inertial measurement unit (IMU) 175, internal to the inertial measurement unit (IMU) 175, or some combination thereof. In FIG. 2A, the position sensors may be located within the inertial measurement unit (IMU) 175, and neither the inertial measurement unit (IMU) 175 nor the position sensors (e.g., head/body tracking sensors 180) may or may not necessarily be visible to the user.

Based on the one or more measurement signals from one or more position sensors, the inertial measurement unit (IMU) 175 may generate calibration data indicating an estimated position of the head-mounted display (HMD) 105 relative to an initial position of the head-mounted display (HMD) 105. In some examples, the inertial measurement unit (IMU) 175 may rapidly sample the measurement signals and calculates the estimated position of the HMD 105 from the sampled data. For example, the inertial measurement unit (IMU) 175 may integrate the measurement signals received from the one or more accelerometers (or other position sensors) over time to estimate a velocity vector and integrates the velocity vector over time to determine an estimated position of a reference point on the head-mounted display (HMD) 105. Alternatively or additionally, the inertial measurement unit (IMU) 175 may provide the sampled measurement signals to a console (e.g.. a computer), which may determine the calibration data. The reference point may be a point that may be used to describe the position of the head-mounted display (HMD) 105. While the reference point may generally be defined as a point in space; however, in practice, the reference point may be defined as a point within the head-mounted display (HMD) 105 (e.g., a center of the inertial measurement unit (IMU) 175).

One or more locators 170, or portions of locators 170, may be located on a front side 220A, a top side 220B, a bottom side 220C, a right side 220D, and a left side 220E of the front rigid body 205 in the example of FIG. 2. The one or more locators 170 may be located in fixed positions relative to one another and relative to a reference point 215. In FIG. 2, the reference point 215, for example, may be located at the center of the inertial measurement unit (IMU) 175. Each of the one or more locators 170 may emit light that is detectable by an imaging device (e.g., camera or an image sensor).

FIG. 2B illustrates a head-mounted displays (HMDs), in accordance with another example. As shown in FIG. 2B, the head-mounted display (HMD) 105 may take the form of a wearable, such as glasses. The head-mounted display (HMD) 105 of FIG. 2B may be another example of the head-mounted display (HMD) 105 of FIG. 1. The head-mounted display (HMD) 105 may be part of an artificial reality (AR) system, or may operate as a stand-alone, mobile artificial realty system configured to implement the techniques described herein.

In some examples, the head-mounted display (HMD) 105 may be glasses comprising a front frame including a bridge to allow the head-mounted display (HMD) 105 to rest on a user’s nose and temples (or “arms”) that extend over the user’s ears to secure the head-mounted display (HMD) 105 to the user. In addition, the head-mounted display (HMD) 105 of FIG. 2B may include one or more interior-facing electronic displays 203A and 203B (collectively, “electronic displays 203”) configured to present artificial reality content to a user and one or more varifocal optical systems 205A and 205B (collectively, “varifocal optical systems 205”) configured to manage light output by interior-facing electronic displays 203. In some examples, a known orientation and position of display 203 relative to the front frame of the head-mounted display (HMD) 105 may be used as a frame of reference, also referred to as a local origin, when tracking the position and orientation of the head-mounted display (HMD) 105 for rendering artificial reality (AR) content, for example, according to a current viewing perspective of the head-mounted display (HMD) 105 and the user.

As further shown in FIG. 2B, the head-mounted display (HMD) 105 may further include one or more motion sensors 206, one or more integrated image capture devices 138A and 138B (collectively, “image capture devices 138”), an internal control unit 210, which may include an internal power source and one or more printed-circuit boards having one or more processors, memory, and hardware to provide an operating environment for executing programmable operations to process sensed data and present artificial reality content on display 203. These components may be local or remote, or a combination thereof.

Although depicted as separate components in FIG. 1, it should be appreciated that the head-mounted display (HMD) 105, the imaging device 110, the I/O interface 115, and the console 120 may be integrated into a single device or wearable headset. For example, this single device or wearable headset (e.g., the head-mounted display (HMD) 105 of FIGS. 2A-2B) may include all the performance capabilities of the system 100 of FIG. 1 within a single, self-contained headset. Also, in some examples, tracking may be achieved using an “inside-out” approach, rather than an “outside-in” approach. In an “inside-out” approach, an external imaging device 110 or locators 170 may not be needed or provided to system 100. Moreover, although the head-mounted display (HMD) 105 is depicted and described as a “headset,” it should be appreciated that the head-mounted display (HMD) 105 may also be provided as eyewear or other wearable device (on a head or other body part), as shown in FIG. 2A. Other various examples may also be provided depending on use or application.

### Flare and Ghost Effects in an Imaging Sensor With a Micro Lens Array (MLA)

As described above, a conventional imaging sensor (e.g. used in a head-mounted display (HMD), digital camera, computing device, etc.) may not be able to utilize or detect all the optical illumination for one reason or another. Traditional approaches to solve this problem include placing a micro lens array (MLA) on the sensor itself; however, such an approach may cause undesirable effects, such as flares or ghosts.

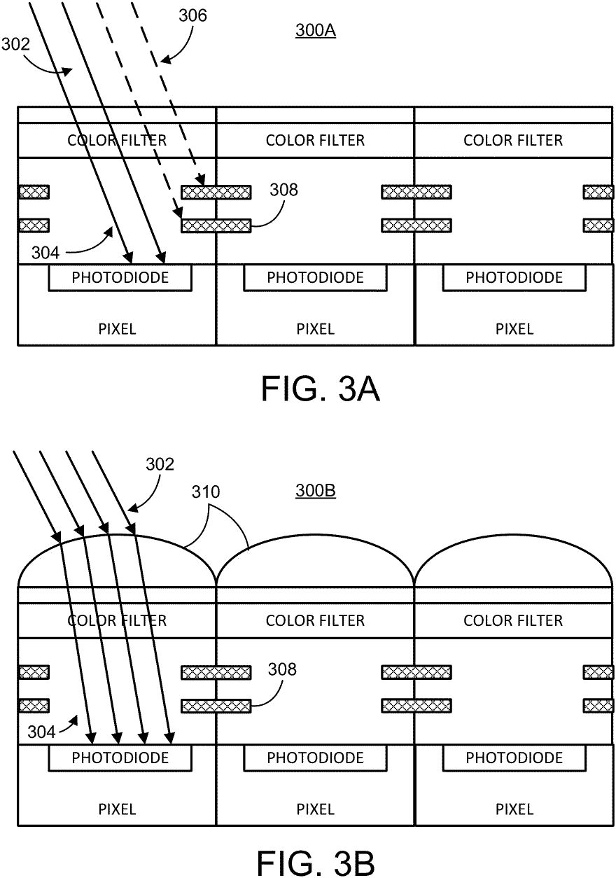

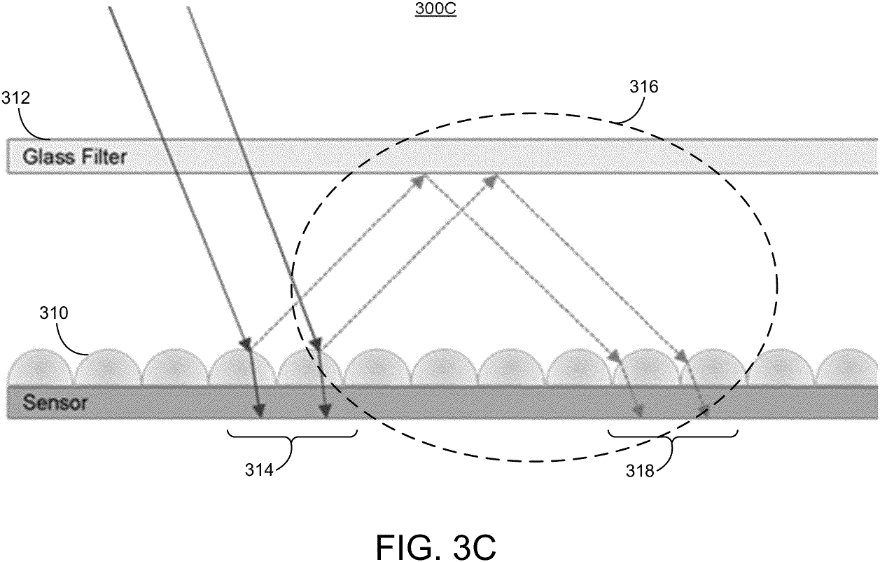

FIGS. 3A-3C illustrate schematic diagrams 300A-300C of various imaging sensor configurations, according to an example. In the schematic diagram 300A of FIG. 3A, an imaging sensor configuration may be shown. Here, the imaging sensor configuration may include optical illumination 302 that is incident on a top layer of the imaging sensor. Some of the optical illumination 302 may pass through at least one color filter to become optical signals 304 that reach at least one photodiode per pixel, as shown. However, not all of the optical illumination 302 may make it to the photodiode in this imaging sensor configuration. For example, there may some optical rays or signals 306 that are not detected by the photodiode. There may be any number of reasons for this, but in some examples, these optical rays or signals 306 may be blocked by one or more sensor elements 308, as shown. The one or more sensor elements 308 may include any sensor structure that hinders the optical rays or signals 306 from reaching or being detected by the photodiode. In some examples, the one or more sensor elements 308 that block the optical rays or signals 308 may be structures that link the pixels together, as shown.

To help alleviate these issues, the schematic diagram 300B of FIG. 3B may illustrate an imaging sensor configuration with a micro lens array (MLA) 310. The schematic diagram 300B is similar to the schematic diagram 300A, however, the schematic diagram 300B of the imaging sensor configuration includes a micro lens array (MLA) 310, which may help focus and/or provide more optical illumination 302 incident on the imaging sensor towards the photodiode, as shown. Here, most (if not all) of the optical illumination 302 becomes optical signals 304 that reach the photodiode.

Although use of a micro lens array (MLA) 310 may help focus and funnel more light to the photodiode of the sensor, the micro lens array (MLA) 310, however, may cause unwanted flare or ghost effects. FIG. 3C illustrates a schematic diagram 300C of an imaging sensor configuration to help illustrates how these adverse effects are generated. As shown, the imaging sensor configuration may include a glass filter 312 and a micro lens array (MLA) 310 over a sensor layer. By definition, a micro lens array (MLA) 310 may include a plurality of little dome-like lenses, the surface, contour, or shape of these micro lenses may cause the optical illumination to be reflected within an area 316 between the glass filter 312 and the sensor.

For example, the optical illumination incident on the surface of the micro lens array (MLA) 310 may include one or more chief rays 314 and one or more reflected illumination 318 that may bounce back and forth within the area 316 between the glass filter 310 and the sensor. Because the sensor not only detects the one or more chief rays 314, but also the one or more reflected illumination 318, the resulting effect may include petal-like flare or ghosts in a sensor image produced by the imaging sensor assembly.

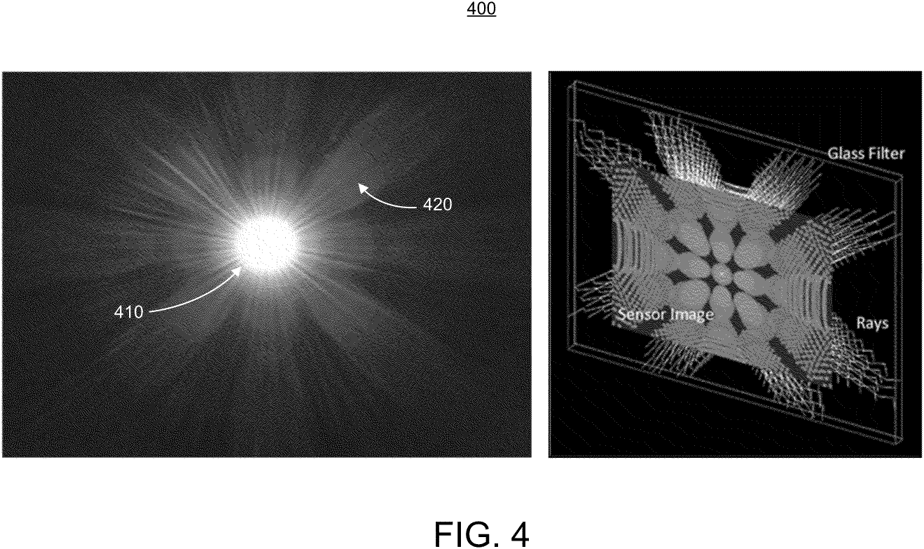

FIG. 4 illustrates a sensor image 400 depicting flare or ghost effects of an imaging sensor configuration using the micro lens array (MLA) 310 of FIG. 3C, according to an example. As shown, the sensor image 400 may depict a central region 410 that corresponds to one or more chief rays 314 of FIG. 3C. The sensor image 400, however, may also depict an undesirable peripheral region 420 that corresponds to the one or more reflected rays 318 in the area 316 of FIG. 3C. In some examples, this peripheral region 420 may include ghosts or petal-shaped flare effects caused by the micro lens array (MLA) 310 of FIG. 3C.

### Imaging Sensor Using a Diffractive Optical Element (DOE)

The systems and methods described herein may provide an improved approach to solve at least two technical issues associated with a conventional imaging sensor: (1) focus or provide optical illumination (e.g., chief rays) to a photodiode of each pixel; and (2) reduce ghosts, flare, or other undesirable effects that result from use of dome-shaped lenses of a micro lens array (MLA). To achieve these goals, the systems and methods described herein may employ a diffractive optical element (DOE) to achieve these purposes.

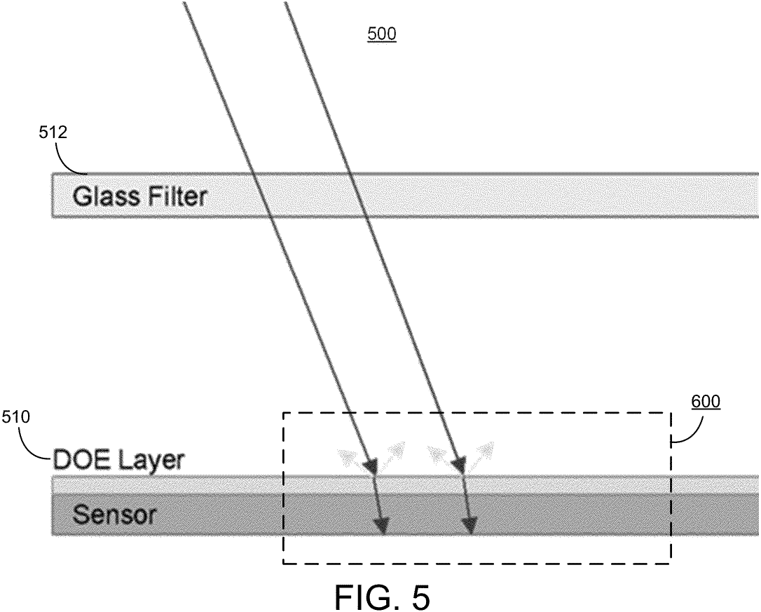

FIG. 5 illustrates a schematic diagram 500 of an imaging sensor configuration using a diffractive optical element (DOE) 510, according to an example. As shown, optical illumination may pass through a glass filter 512, similar to that shown in FIG. 3C. However, rather than passing through a micro lens array (MLA) 310 of FIG. 3C, the optical illumination may pass through a diffractive optical element (DOE) 510 before being detected by one or more photodiodes (not shown) of the sensor layer. A cross-section 600 of the schematic diagram 500 may illustrate an imaging sensor configuration using a variety of diffractive optical elements (DOEs), described in more detail below.

The diffractive optical element (DOE) 510 may include any number of diffractive optical elements (DOEs). In some examples, the diffractive optical element (DOE) 510 may include, but not limited to the following: a Fresnel lens, a Fresnel zone plate, a kinoform lens, a holographic optical element (e.g., hologram), a metalens, or other diffractive element.

A Fresnel lens may be a type of compact optical lens that generally has a reduced amount of material compared to a conventional lens performing a similar feature or function. This occurs by dividing a lens into a set of concentric annular sections. An ideal Fresnel lens may have an infinite number of sections, where in each section, the overall thickness is decreased relative to an equivalent simple conventional lens. One major benefit of a Fresnel lens may be its thin design profile, which may allow a substantial reduction in thickness (and thus mass and volume of material). More details of a Fresnel lens may be provided below.

A Fresnel zone plate may be an optical device that is used to focus light or other items exhibit wave-like character. Such optical focusing may be based on diffraction rather than refraction or reflection, and may be an extension of the Arago spot phenomenon. Similar to a Fresnel lens, a Fresnel zone plate may include a set of concentric rings, or Fresnel zones, which alternate between being opaque and transparent. When the zones are spaced sufficiently so that light constructively interferes at the desired focus, an image may be created there. Accordingly, a Fresnel zone plate may be used as imaging lenses with a single focus.

A kinoform lens may be a type of converging lens. In some examples, a kinoform lens may have an efficient focusing ability for a variety of illumination, including x-ray radiation, and helpful in imaging nanomaterials or other small objects or items.

A holographic optical element may be any number of optical element, such as mirrors, lenses, directional diffusers, etc. that can produce a hologram or holographic image using principles of diffraction. This holographic effect may be provided by superimposing a second wavefront (normally called a reference beam) on a wavefront of interest, thereby generating an interference pattern, which may be used in a variety of augmented reality (AR) or mixed reality (MR) applications.

A metalens, sometimes referred to as a superlens, may be a lens that utilizes metamaterials to go beyond a given diffraction limit, which may be based on a feature of conventional lenses and microscopes that limits fineness of resolution. In other words, a metalens may utilize subwavelength imaging techniques to reconstruct nanometer sized images by producing a negative refractive index in each instance, which may compensate for swiftly decaying evanescent waves. In this way, a metalens not only provides a smaller form factor, but high resolution imaging capabilities.

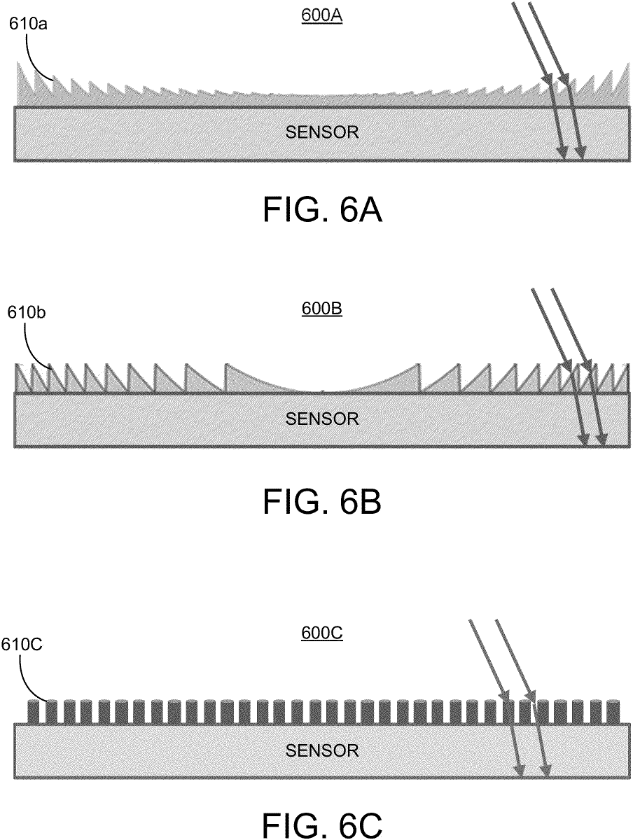

By way of example, FIGS. 6A-6C illustrate cross-sectional schematic diagrams 600A-600C of various diffractive optical elements (DOEs) 610a-610c for an imaging sensor configuration, according to an example. As shown in cross-sectional schematic diagram 600A, a Fresnel lens 610a may be provided. As shown in cross-sectional schematic diagram 600B, a kinoform lens 610b may be provided. As shown in cross-sectional schematic diagram 600C, a metalens 610c may be provided. It should be appreciated that these exemplary diffractive optical elements (DOE) may include a surface, contour, or shape that is different from that of a micro lens array (MLA). Accordingly, a diffractive optical element (DOE) 510 provided by the systems and methods described herein, and as shown in FIG. 5, not only focus or provide maximize optical illumination to the sensor, but also minimize reflection that may result in ghosts or pedal-like flares found in conventional imaging sensors.

Not only do the systems and methods provide an effective way to reduce ghosts or flare, the use of a diffractive optical element (DOE) may improve image quality capture as well. Moreover, a diffractive optical element (DOE) may also have a thinner profile than a conventional micro lens array (MLA). In addition, the systems and methods described herein may be compatible with existing imaging sensor configurations. Thus, one may easily provide a diffractive optical element (DOE) to existing sensors to achieve the desired results. Accordingly, the systems and method described herein may also provide a flexible and low-cost way to improve visual acuity while also decreasing size, thickness, or overall bulkiness of the imaging sensors. In fact, a thickness of the diffractive optical element (DOE) used and provided in the systems and methods, described herein, may be in the range of 1-10 µm, or other suitable thickness.

It should be appreciated that using a diffractive optical element (DOE) is not as easy as replacing a conventional micro lens array (MLA). There may be any number of manufacturing design and/or optimization considerations to be taken into account in order to adequately and sufficiently provide the diffractive optical element (DOE), as described herein. For example, the size of the diffractive optical element (DOE), in most cases, may be rather large, or at least relatively larger than a conventional micro lens array (MLA), which is formed by a plurality of tiny lenses that are substantially identical. From a design perspective, the micro lens array (MLA) is based on refraction, but the diffractive optical element (DOE) may be based on diffraction. As a result, this may require special design on each field and the structure on the diffractive optical element (DOE) may be related to incident angles and a chief ray angle (CRA) hitting the sensor below the diffractive optical element (DOE). This is clearly unique from layering a sensor with a micro lens array, where each tiny lens is substantially identical and having predictable radial distributions. However, each the diffractive optical element (DOE), which has a unique shape, may be different based on any number of field angles. As a result, the systems and methods described herein may provide the diffractive optical element (DOE) layer over the sensor in a manner that is efficient and reliable, taking into account the numerous design and optimization challenges that is not typically encountered with a conventional micro lens array (MLA) layer.

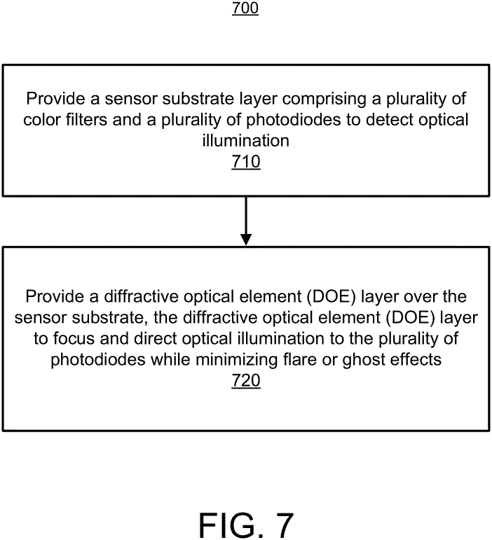

FIG. 7 illustrates a flow chart of a method 700 for providing a diffractive optical element (DOE) in an imaging sensor configuration, according to an example. The method 700 is provided by way of example, as there may be a variety of ways to carry out the method described herein. Although the method 700 is primarily described as being performed by the system 100 of FIG. 1 and/or imaging sensor configuration 500 of FIG. 5, the method 700 may be executed or otherwise performed by one or more processing components of another system or a combination of systems. Each block shown in FIG. 7 may further represent one or more processes, methods, or subroutines, and one or more of the blocks may include machine readable instructions stored on a non-transitory computer readable medium and executed by a processor or other type of processing circuit to perform one or more operations described herein.

At 710, a sensor substrate layer may be provided. In some examples, the substrate layer may include a plurality of color filters and a plurality of photodiodes to detect optical illumination.

At 720, a diffractive optical element (DOE) layer may be provided over the sensor substrate layer. As described above, the diffractive optical element (DOE) layer may be provided over the sensor substrate layer using any number of layering techniques. These may include, but not limited to, a laminating technique, a coating technique, a spraying technique, a dipping technique, a sputtering technique, a masking technique, an etching technique, a deposition technique, and/or any other applicable layering technique.

It should be appreciated that the diffractive optical element (DOE) layer may help focus and direct optical illumination to the plurality of photodiodes while minimizing flare or ghost effects. In some examples, this minimization of flare and ghost effects may be achieved based at least in part on a surface, contour, or shape of the diffractive optical element (DOE) layer, as described herein.

In some examples, the diffractive optical element (DOE) layer may include a Fresnel lens, a Fresnel zone plate, a kinoform lens, a holographic optical element, a metalens, and/or other optical layer. In some examples, the diffractive optical element (DOE) layer may have a thickness in the range of 1-10 µm. Additionally, the diffractive optical element (DOE) layer may be layered on the sensor substrate based on information associated with one or more incident angles or a chief ray angle incident on at least one of the photodiodes.

It should be appreciated that any number of techniques may be used to provide the diffractive optical element (DOE) layer over the sensor layer. In some examples, these may include, but not limited to laminating, coating, spraying, dipping, sputtering, masking, etching, deposition, or other similar technique. In some examples, lamination may be a technique to provide the diffractive optical element (DOE) layer with low cost and highly efficiency machinery and related processes. In a mass production (MP) scenario, lamination may also provide a diffractive optical element (DOE) layer that is more easily usable, especially when attaching to lenses or sensor substrates. That said, any of the other methods or techniques may be useful as well, although some of these processes may not be as efficient and may be constrained by other factors, such as lens shape, size, slope, etc.

### Additional Information

The systems and methods described herein may provide a technique for reducing flare or ghosts and enhancing sharpness using a diffractive optical element (DOE) in an imaging sensor assembly, which, for example, may be used in a head-mounted display (HMD) or other optical applications.

The benefits and advantages of the imaging sensor configurations described herein, may include, among other things, reduction in ghosts and flare while maintaining or minimizing overall lens assembly thickness, increasing product flexibility and efficiency, and improved resolution. This may be achieved in any number of environments, such as in virtual reality (VR), augmented reality (AR), and/or mixed reality (MR) environments, or other optical scenarios.

As mentioned above, there may be numerous ways to configure, provide, manufacture, or position the various optical, electrical, and/or mechanical components or elements of the examples described above. While examples described herein are directed to certain configurations as shown, it should be appreciated that any of the components described or mentioned herein may be altered, changed, replaced, or modified, in size, shape, and numbers, or material, depending on application or use case, and adjusted for desired resolution or optimal results. In this way, other electrical, thermal, mechanical and/or design advantages may also be obtained.

It should be appreciated that the apparatuses, systems, and methods described herein may facilitate more desirable headsets or visual results. It should also be appreciated that the apparatuses, systems, and methods, as described herein, may also include or communicate with other components not shown. For example, these may include external processors, counters, analyzers, computing devices, and other measuring devices or systems. In some examples, this may also include middleware (not shown) as well. Middleware may include software hosted by one or more servers or devices. Furthermore, it should be appreciated that some of the middleware or servers may or may not be needed to achieve functionality. Other types of servers, middleware, systems, platforms, and applications not shown may also be provided at the back-end to facilitate the features and functionalities of the headset.

Moreover, single components described herein may be provided as multiple components, and vice versa, to perform the functions and features described above. It should be appreciated that the components of the apparatus or system described herein may operate in partial or full capacity, or it may be removed entirely. It should also be appreciated that analytics and processing techniques described herein with respect to the imaging sensor configurations, for example, may also be performed partially or in full by these or other various components of the overall system or apparatus.

It should be appreciated that data stores may also be provided to the apparatuses, systems, and methods described herein, and may include volatile and/or nonvolatile data storage that may store data and software or firmware including machine-readable instructions. The software or firmware may include subroutines or applications that perform the functions of the measurement system and/or run one or more application that utilize data from the measurement or other communicatively coupled system.

The various components, circuits, elements, components, and/or interfaces, may be any number of optical, mechanical, electrical, hardware, network, or software components, circuits, elements, and interfaces that serves to facilitate communication, exchange, and analysis data between any number of or combination of equipment, protocol layers, or applications. For example, some of the components described herein may each include a network or communication interface to communicate with other servers, devices, components or network elements via a network or other communication protocol.

Although examples are generally directed to head-mounted displays (HMDs), it should be appreciated that the apparatuses, systems, and methods described herein may also be used in other various systems and other implementations. For example, these may include other various head-mounted systems, eyewear, wearable devices, optical systems, etc. in any number of virtual reality (VR), augmented reality (AR), and/or mixed reality (MR) environments, or beyond. In fact, there may be numerous applications in various optical or data communication scenarios, such as optical networking, cameras, image sensing or processing, etc.

It should be appreciated that the apparatuses, systems, and methods described herein may also be used to help provide, directly or indirectly, measurements for distance, angle, rotation, speed, position, wavelength, transmissivity, and/or other related optical measurements. For example, the systems and methods described herein may allow for a higher optical resolution and increased system functionality using an efficient and cost-effective design concept. With additional advantages that include higher resolution, lower number of optical elements, more efficient processing techniques, cost-effective configurations, and smaller or more compact form factor, the apparatuses, systems, and methods described herein may be beneficial in many original equipment manufacturer (OEM) applications, where they may be readily integrated into various and existing equipment, systems, instruments, or other systems and methods. The apparatuses, systems, and methods described herein may provide mechanical simplicity and adaptability to small or large headsets. Ultimately, the apparatuses, systems, and methods described herein may increase resolution, minimize adverse effects of traditional systems, and improve visual efficiencies.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims-and their equivalents-in which all terms are meant in their broadest reasonable sense unless otherwise indicated.

1. An imaging sensor assembly, comprising:
a diffractive optical element (DOE); and
a sensor substrate under the diffractive optical element (DOE), the sensor substrate comprising:
a plurality of color filters; and
a plurality of photodiodes to detect optical illumination that passes through the diffractive optical element (DOE) to create one or more images.

2. The imaging sensor assembly of claim 1, wherein the diffractive optical element (DOE) focuses and directs optical illumination to the plurality of photodiodes, and minimizes flare or ghost effects.

3. The imaging sensor assembly of claim 2, wherein at least a surface, contour, or shape of the diffractive optical element (DOE) causes minimization of flare or ghost effects.

4. The imaging sensor assembly of claim 1, wherein the diffractive optical element (DOE) comprises at least one of a Fresnel lens, a Fresnel zone plate, a kinoform lens, a holographic optical element, or a metalens.

5. The imaging sensor assembly of claim 1, wherein the diffractive optical element (DOE) comprises a thickness of 1-10 µm.

6. The imaging sensor assembly of claim 1, wherein the diffractive optical element (DOE) is layered and positioned on the sensor substrate based on at least information associated with one or more incident angles or a chief ray angle incident on at least one of the photodiodes.

7. The imaging sensor assembly of claim 1, wherein the imaging sensor assembly is provided in at least one of a head-mounted display (HMD), an imaging device, a digital camera, or an opto-electrical device.

8. A head-mounted display (HMD), comprising:
a display element to provide optical illumination; and
an imaging sensor assembly to provide images to a user of the head-mounted display (HMD), the imaging sensor assembly comprising:
a diffractive optical element (DOE); and
a sensor substrate under the diffractive optical element (DOE), the sensor substrate comprising:
a plurality of color filters; and
a plurality of photodiodes to detect optical illumination that passes through the diffractive optical element (DOE) to create one or more images.

9. The head-mounted display (HMD) of claim 8, wherein the diffractive optical element (DOE) focuses and directs optical illumination to the plurality of photodiodes, and minimizes flare or ghost effects.

10. The head-mounted display (HMD) of claim 9, wherein at least a surface, contour, or shape of the diffractive optical element (DOE) causes minimization of flare or ghost effects.

11. The head-mounted display (HMD) of claim 8, wherein the diffractive optical element (DOE) comprises at least one of a Fresnel lens, a Fresnel zone plate, a kinoform lens, a holographic optical element, or a metalens.

12. The head-mounted display (HMD) of claim 8, wherein the diffractive optical element (DOE) comprises a thickness of 1-10 µm.

13. The head-mounted display (HMD) of claim 8, wherein the diffractive optical element (DOE) is layered on the sensor substrate based on at least information associated with one or more incident angles or a chief ray angle incident on at least one of the photodiodes.

14. A method for providing a diffractive optical element (DOE) in an imaging sensor assembly, comprising:
providing a sensor substrate layer comprising a plurality of color filters and a plurality of photodiodes to detect optical illumination; and
providing a diffractive optical element (DOE) layer over the sensor substrate layer, the diffractive optical element (DOE) layer to focus and direct optical illumination to the plurality of photodiodes while minimizing flare or ghost effects.

15. The method of claim 14, wherein the diffractive optical element (DOE) layer is provided over the sensor substrate layer using a layering technique.

16. The method of claim 15, wherein the layering technique comprises at least one of a laminating technique, a coating technique, a spraying technique, a dipping technique, a sputtering technique, a masking technique, an etching technique, or a deposition technique.

17. The method of claim 14, wherein at least a surface, contour, or shape of the diffractive optical element (DOE) layer causes minimization of flare or ghost effects.

18. The method of claim 14, wherein the diffractive optical element (DOE) layer comprises at least one of a Fresnel lens, a Fresnel zone plate, a kinoform lens, a holographic optical element, or a metalens.

19. The method of claim 14, wherein the diffractive optical element (DOE) layer comprises a thickness of 1-10 µm.

20. The method of claim 14, wherein the diffractive optical element (DOE) layer is layered on the sensor substrate layer based on at least information associated with one or more incident angles or a chief ray angle incident on at least one of the photodiodes.
